(19) United States
(12) Patent Application Publication
(10) Pub. No.: US 2015/0170031 A1
(43) Pub. Date: Jun. 18, 2015

(54) DETERMINING PARKING OF A VEHICLE

(71) Applicant: GOOGLE Inc., (US)

(72) Inventors: Mohammad Hossain Sheikh Attar, Richmond Hill (CA); Jerred James Costanzo, York (CA); Michael James Taylor, Kitchener (CA)

(73) Assignee: GOOGLE Inc., Mountain View, CA (US)

(21) Appl. No.: 13/875,126

(22) Filed: May 1, 2013

(51) Int. Cl. G06N 5/02

(52) U.S. Cl. CPC G06N 5/02

(57) ABSTRACT

Systems, methods, and computer-readable media for determining parking of a vehicle are provided. One or more possible parking indicators associated with a user and a vehicle are obtained. The possible parking indicators include a manual parking confirmation, a disconnection from a vehicle dock, a disconnection from a vehicle's short-range, an acceleration determination based on data obtained from an accelerometer of the portable computer, the location of the portable computer at a known parking location, an arrival at a user-specific destination, and the location of the portable computer at a high traffic location. Certainty measures are assigned to each obtained possible parking indicator and the probability of a parking event is determined.

### BACKGROUND OF THE INVENTION

1. Field of the Invention

This invention relates generally to vehicle transportation and, more particularly, to processing various types of data to determine if a vehicle is parked.

2. Description of the Related Art

Personal vehicles such as cars, motorcycles, and other vehicles are used to transport users (e.g., drivers) of such vehicles to various destinations. A vehicle is driven to a destination and then parked in a location at or near the destination. In some instances, the parking locations are large and difficult to navigate. The user of a vehicle may not be able to remember the exact location of their vehicle and may have difficulty locating their vehicle after returning to the parking location. Additionally, the user may rely on a portable computer to save the location of the vehicle. However, use of a portable computer in this manner requires the user to remember to save the vehicle location before leaving the vehicle.

### SUMMARY OF THE INVENTION

Various embodiments of systems, methods, and computer-readable media are provided herein. In some embodiments, a computer-implemented method for determining parking of a vehicle is provided. The method includes obtaining, by one or more processors, one or more parking indicators associated with a user and a vehicle. The parking indicators include a manual parking confirmation from a user of a portable computer, a disconnection of the portable computer from a dock of the vehicle, a disconnection of the portable computer from a short-range radio provided by the vehicle, a determination based on data received from an accelerometer of the portable computer, a determination that a location of the portable computer is a known parking location, an arrival at a user-specific destination, and the a determination that the location of the portable computer is not in a high traffic area. The method further includes calculating, by one or more processors, a probability of a parking event of the vehicle based on the one or more parking indicators and determining, by one or more processors, that the probability of the parking event is greater than a threshold value. Additionally, the method includes storing, by one or more processors, the location of the parking event on the portable computer.

Additionally, in some embodiments, a non-transitory tangible computer-readable storage medium having executable computer code stored thereon for determining parking of a vehicle. The computer code includes a set of instructions that causes one or more processors to perform the following: obtaining, by one or more processors, one or more parking indicators associated with a user and a vehicle. The parking indicators include a manual parking confirmation from a user of a portable computer, a disconnection of the portable computer from a dock of the vehicle, a disconnection of the portable computer from a short-range radio provided by the vehicle, a determination based on data received from an accelerometer of the portable computer, a determination that a location of the portable computer is a known parking location, an arrival at a user-specific destination, and a determination that the location of the portable computer is not in a high traffic area. The code further includes a set of instructions that causes one or more processors to perform the following: calculating, by one or more processors, a probability of a parking event of the vehicle based on the one or more parking indicators and determining, by one or more processors, that the probability of the parking event is greater than a threshold value. Additionally, the code further includes a set of instructions that causes one or more processors to perform the following: includes storing, by one or more processors, the location of the parking event on the portable computer.

In some embodiments, a system is provided that includes one or more processors and a tangible non-transitory memory accessible by the one or more processors. The computer code includes a set of instructions that causes one or more processors to perform the following: obtaining, by one or more processors, one or more parking indicators associated with a user and a vehicle. The parking indicators include a manual parking confirmation from a user of a portable computer, a disconnection of the portable computer from a dock of the vehicle, a disconnection of the portable computer from a short-range radio provided by the vehicle, a determination based on data received from an accelerometer of the portable computer, a determination that a location of the portable computer is a known parking location, an arrival at a user-specific destination, and a determination that the location of the portable computer not in a high traffic area. The code further includes a set of instructions that causes one or more processors to perform the following: calculating, by one or more processors, a probability of a parking event of the vehicle based on the one or more parking indicators and determining, by one or more processors, that the probability of the parking event is greater than a threshold value. Additionally, the code further includes a set of instructions that causes one or more processors to perform the following: includes storing, by one or more processors, the location of the parking event on the portable computer.

### BRIEF DESCRIPTION OF THE DRAWINGS

FIG. 1 is a block diagram of a process for determining parking of a vehicle associated with a user in accordance with an embodiment of the present invention;

FIG. 2 is a block diagram of a process for assigning certainty measures to possible parking indicators based on a portable computer location in accordance with an embodiment of the present invention;

FIG. 3 is a block diagram of a system for determining parking of a vehicle associated with a user in accordance with an embodiment of the present invention; and

FIG. 4 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for determining parking of a vehicle associated with a user. A portable computer associated with the vehicle or the user (e.g., a mobile user device of a driver or passenger of the vehicle) obtains one or more possible parking indicators within a given duration or period of time. The possible parking indicators include: a manual parking confirmation (e.g., an input from a user to store a location as the location of the parked vehicle); a disconnection from a vehicle dock; a disconnection from a vehicle's short-range radio (e.g., Bluetooth® or other in-vehicle networking protocol); an acceleration determination based on data obtained from an accelerometer of the portable computer; the location of the portable computer at a known parking location; an arrival at a user-specific destination (e.g., a destination entered into a computer-based navigation application, a heuristically learned location associated with the user, or other destinations) and the location of the portable computer at a high traffic location (e.g., based on a traffic measurement obtained from a remote entity that provides traffic information).

After obtaining one or more possible parking indicators, certainty measures are assigned to each possible parking indicator. The probability of a parking event is calculated from the certainty measures and compared to a threshold. If the probability of the parking event is above the threshold, the vehicle is determined to be parked and the parking event is stored. In some embodiments, the location of the parking event is also stored.

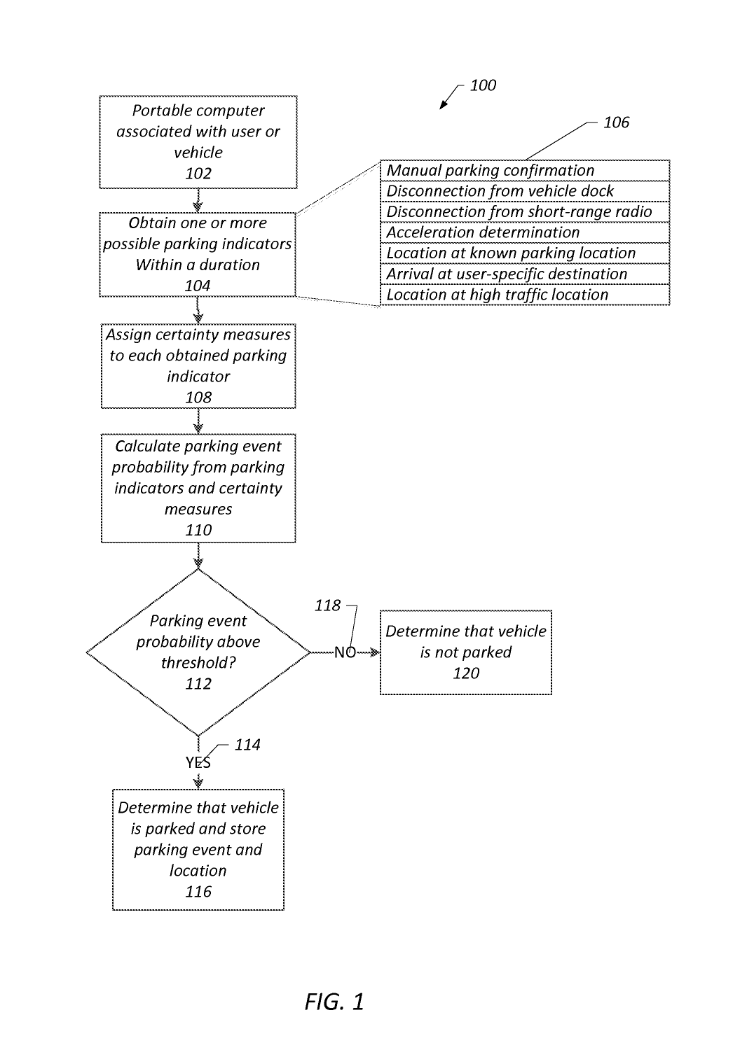

FIG. 1 is depicts a process 100 for determining parking of a vehicle associated with a user or a vehicle in accordance with an embodiment of the present invention. Some or all steps of the process 100 may be implemented as executable computer code stored on a non-transitory tangible computer-readable storage medium and executed by one or more processors of a special-purpose machine, e.g., a general purpose computer programmed to execute the code. As shown in FIG. 1, the process 100 may be initiated by a portable computer 102 associated with the user. The user of the portable computer 102 may be a driver of the vehicle or a passenger in the vehicle.

One or more possible parking indicators 106 within a given duration or period of time are obtained (block 104). As described further below, the possible parking indicators 106 may include: a manual parking confirmation (e.g., an input from a user to store a location as the location of a parked vehicle); a disconnection from a vehicle dock; a disconnection from a vehicle's Bluetooth connection or other in-vehicle network; an acceleration determination based data obtained from the portable computer's accelerometer; the location of the portable computer 102 at a known parking location; an arrival at a user-specific destination (such as a destination entered into a computer-based navigation application) and a traffic measurement at the location of the portable computer 102 (e.g., obtained from a remote system or service that provides traffic information). In some embodiments, the duration is 1 second, 5 seconds, 10 seconds, 20 seconds, 30 seconds, 40 seconds, 50 seconds, one minute, or greater than one minute. In some embodiments, additional possible parking indicators are obtained, such as the detection of a command to lock a vehicle sent from the portable computer 102 to the vehicle.

The manual parking confirmation is based on a user input received by the portable computer 102. For example, the portable computer 102 may execute a program that enables a user to register the current location of their vehicle as a parked location. The program may include a user interface that includes a button, switch, toggle, or other user interface control for selection by a user to indicate that the vehicle is parked at the location. In some embodiments, the manual parking confirmation is not obtained as a possible parking indicator but is instead received in response to a parking event determination based on the other possible parking indicators. For example, after a parking event is determined to have occurred, the user may be presented with a user interface control to manually confirm the occurrence of the parking event.

In some embodiments, the vehicle may include a dock (e.g., a physical connection) configured to receive the portable computer 102. The portable computer 102 may include the capability to determine whether the device is docked or undocked (e.g., via a program of the portable computer 102). After a user parks the vehicle and removes the portable computer 102 from the dock of the vehicle, the disconnection can be detected by the portable computer 102 and used as a potential parking indicator.

In some embodiments, the portable computer 102 can be connected to an in-vehicle short-range wireless network, such as a Bluetooth network, and a disconnection from the short-range radio network (e.g., Bluetooth®) can be used as another possible parking indicator. A vehicle may provide a short-range radio network for transfer of data between the portable computer 102 and a computer of the vehicle, an audio system of the vehicle, or a combination thereof. For example, in such embodiments the audio for a call made via the portable computer 102 may be played using the vehicle audio system via the short-range radio network. The portable computer 102 may include the capability to determine whether the device is connected to the vehicle's short-range radio network (e.g., via a program of the portable computer 102). After a user parks the vehicle and shuts down the vehicle, the vehicle's short-range radio network may also be shutdown, disconnecting the portable computer 102 from the short-range radio. The disconnection is detected by the portable computer 102 and can be used as a possible parking indicator.

In some embodiments, the portable computer 102 includes an accelerometer that measures acceleration of the device. The accelerometer may be used, for example, to detect the orientation of the portable computer 102. In some embodiments, the acceleration or an acceleration profile measured by the accelerometer can indicate whether the user is moving in a vehicle or on foot. For example, the acceleration measured while the user is in a vehicle is likely greater and less periodic than the acceleration of a user on foot, and the acceleration data can be used as a possible parking indicator. For example, the acceleration data may be analyzed (e.g., by a program of the portable computer 102) to determine an acceleration profile for the user, and the acceleration profile may be subject to pattern analysis to determine whether the user is moving in a vehicle or on foot. In some embodiments, the portable user device may store historical accelerometer data and/or categorized acceleration profiles (e.g., walking/on foot profiles), and may determine whether the user is in a vehicle or on foot by comparing the acceleration profile to the historical data or categorized acceleration profiles.

In some embodiments, the user's arrival at a user-specific destination can be used as potential parking indicator. As will be appreciated, the portable computer 102 may include a maps program or other programs that provide directions (e.g., text directions, audio and visual navigation, etc.) from a present location to a user-specific location. The arrival at the user-specific destination may be detected (e.g., via the maps program) and made available as a possible parking indicator.

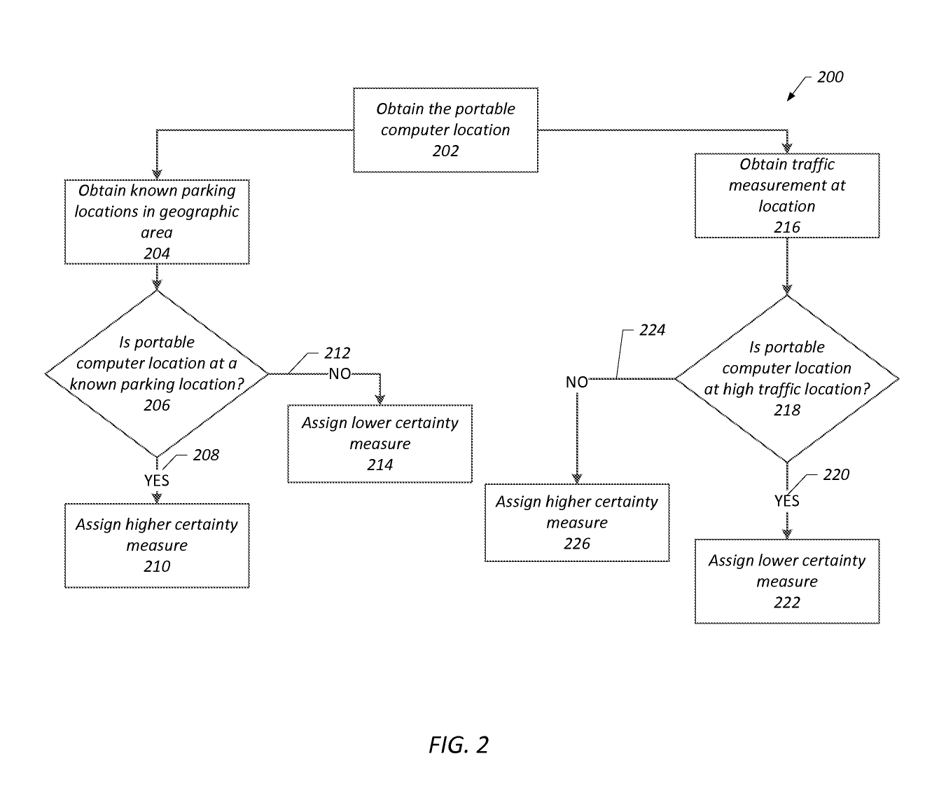

In some embodiments, the location of the portable computer 102 at a known parking location or in a high traffic area can also be used as possible parking indicators. In some embodiments, the portable computer 102 is required to be in the same location for a minimum period of time (e.g., 2 minutes) prior to determining whether the location is a known parking location or that the user is in a high traffic area. In some embodiments, as described further below in FIG. 2, the location of the portable computer 102 is compared to a list of known parking locations in a geographic area to determine a certainty measure that the user's location is a parking location. Additionally, as also described further below in FIG. 2, a traffic measurement can be obtained (such as from a server providing traffic information for geographic area) and used to determine whether the location of the portable computer 102 is in a high traffic area (i.e., indicating the vehicle is merely stuck in traffic rather than parked) or, in a low traffic area (i.e., indicating the vehicle is not stuck in traffic and therefore is likely parked).

Next, certainty measures are assigned to each of the possible parking indicators that have been received. (block 108). The certainty measures may be determined based on analysis of the possible parking indicators 106 over a period of time and may be adjusted based on continual analysis. After assigning certainty measures to the parking indicators, the probability of a parking event is calculated from the obtained parking indicators and the certainty measures (block 110). The parking event probability is compared to a threshold (decision block 112). If the parking event probability is above the threshold (line 114), the vehicle is determined to be parked, and the parking event and location may be stored (block 116). For example, the following possible parking indicators and certainty measures may be detected in a duration of 20 seconds: a disconnection from a vehicle's short-range radio having a certainty measure of about 40%, an arrival at a user-specific destination having a certainty measure of about 40%, and the portable computer location at a high traffic location having a certainty measure of about −20%. In this example, the probability of parking event is about 60% (40%+40%-20%). In some embodiments, a manual parking confirmation may be requested from the user in response to the determination of a parking event. If the parking event probability is below the threshold (line 118), the vehicle is determined not to be parked (block 120). In such instances, the process 100 may begin again, and a subsequent parking determination made based on subsequently received parking indicators in a subsequent time period.

In one embodiment, the possible parking indicators may have the following certainty measures:

Manual parking confirmation=100%

Disconnection from a vehicle dock=30%

Disconnection from a short-range radio=40%

Acceleration determination=20%

Portable computer location in a known parking location=30%

Arrival at a user-specific destination=40%

User location in a high traffic location=−20%

In some embodiments, the determination of a parking event can be shared with and used in subsequent processes or programs (e.g., programs executed by the portable computer to implement the various functions described below). For example, in some embodiments the location of the parking event can be stored and used in directions to subsequently navigate the user to the parked vehicle. In other embodiments, the vehicle's doors can be automatically locked via the portable computer after the user leaves the parking event location for a specified duration. Alternatively, in some embodiments the user can be notified via the portable computer 102 when the user leaves the parking event location if the vehicle's doors are unlocked. In yet other embodiments, the user is notified via the portable computer 102 if the location of the parking event is a metered parking space that requires payment. In some embodiments, the user may also be able to pay for the metered parking space using the portable computer. Additionally, in some embodiments the user may be warned via the portable computer that the location of the parking event is a no-parking area.

FIG. 2 depicts a process 200 for assigning certainty measures to possible parking indicators in accordance with an embodiment of the present invention. Some or all steps of the process 200 may be implemented as executable computer code stored on a non-transitory tangible computer-readable storage medium and executed by one or more processors of a special-purpose machine, e.g., a general purpose computer programmed to execute the code. As described above, the location of a portable computer associated with the user and the vehicle is obtained (block 202). The location of the portable computer is used to determine two possible parking indicators: whether the vehicle associated with the user is at a known parking location (e.g., implying that the vehicle associated with the user is parked at the parking location) and whether the user is in a high traffic location (i.e., implying that the vehicle associated with the user is merely stuck in traffic and not parked). In some embodiments, these determinations are only made if the portable computer has remained in the same location for a minimum period of time (e.g., two minutes). A running log of the location of the portable computer may be kept, for a duration of this minimum period of time (e.g., two minutes in the example above), allowing the portable computer to more accurately determine the location of a near past parking event. The interval of location samples could (not necessarily) be configured automatically or manually to optimize for battery life of the portable computer or parking location accuracy.

To determine if the vehicle associated with the user is in a known parking location, known parking locations in a geographic area that includes the portable computer location are obtained (block 204). The known parking locations may include parking garages, parking lots, parking spaces, and other known parking locations. In some embodiments, the known parking locations include user-specific parking locations, such as a user's residence, workplace, and the like. The portable computer location is compared to the known parking locations to determine if the vehicle associated with the portable computer is located at a known parking location (decision block 206). If the portable computer location is at a known parking location (line 208), the possible parking indicator is assigned a higher certainty measure (block 210). If the portable computer location is not at a known parking location (line 212), the possible parking indicator is assigned a lower certainty measure (block 214).

As mentioned above, the portable computer location may also be used to determine whether the vehicle is in a high traffic location. To perform this determination, a traffic measurement in an area that includes the portable computer location is obtained (block 216). The traffic measurement may be obtained from any suitable entity that provides traffic information, such as a map-based service, a geographic information system, a traffic information website or other suitable system or service. The traffic measurement is used to determine if the portable computer is in a high traffic area or at a high traffic location (decision block 218). If the portable computer is in a high traffic area or at a high traffic location (line 220), the possible parking indicator is assigned a lower certainty measure (block 222) (i.e., it is likely that the vehicle is merely stuck in traffic and not parked). In contrast, if the portable computer is not in a high traffic area or at a high traffic location (line 224), the possible parking indicator is assigned a higher certainty measure (block 226) (i.e., the vehicle is likely parked and not stuck in traffic).

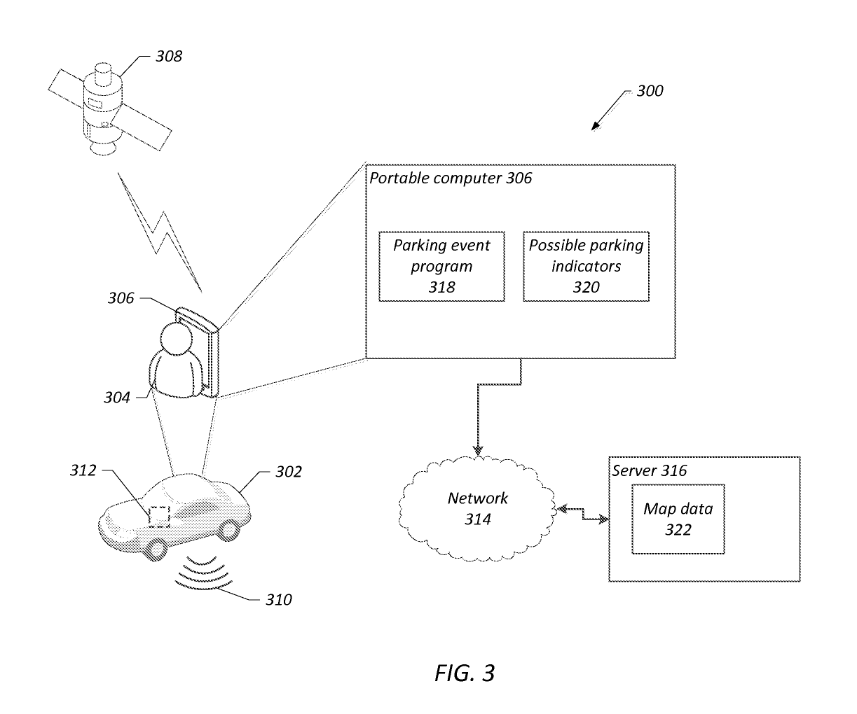

FIG. 3 depicts an embodiment of a system 300 for detecting parking of a vehicle 302 in accordance with an embodiment of the present invention. As shown in FIG. 3, the system 300 includes include a user 304 interacting with a computer, e.g., portable computer 306. The user may be a driver or a passenger of the vehicle 302. The portable computer 306 may include laptop computers, tablet computers, smartphones, personal digital assistants, standalone navigation systems, etc., and may include a receiver for a satellite-based navigation system 308, such as a Global Positioning System (GPS) receiver. The vehicle 302 may include automobiles, motorcycles, scooters, or any other personal vehicles. The vehicle 302 may also provide various components for interaction with the portable computer 306, such as a short-range radio 310 and a dock 312. In some embodiments, the user 304 in the vehicle 302 may use the portable computer 306 to view interactive maps, find and input destinations, receive routes to destinations, and receive voice or text navigations to destinations.

As shown in FIG. 3, the system 300 also includes a network 314 and a server 316. The portable computer 306 can be in communication with both the network 314 and the satellite-based positioning system 308. For example, as the portable computer 306 and the vehicle 302 traverse geographic areas, the position of the portable computer 306 may be determined via communication with the satellite-based navigation system 308. In some embodiments, the position of the portable computer may also be determined from the network 314, such as from tokens obtained from the network 314 (e.g., by geolocating an IP address), signals received from the network 314 (e.g., by triangulating signals received from Wi-Fi or cellular communications access points) and so on. The position may be stored on a memory of the portable computer 306 and used in further processing, as described below.

The network 314 may include multiple networks, such as a wireless Ethernet network, a cellular network, or other wireless networks. Moreover, it should be appreciated that the portable computer 306 and the server 316 may each communicate over additional and different networks. For example, the portable computer 306 may communicate over the network 314 and a different cellular network (not shown). In other embodiments, the portable computer 306 may not be in communication with network 314 or other networks.

The server 316 may be a single server (in a discrete hardware component or as a virtual server) or multiple servers. The server 316 may include web servers, application servers, or other types of servers. Additionally, the server 316 may include computers arranged in any physical and virtual configuration, such as computers in one or more data processing centers, a distributed computing environment, or other configuration. Such configurations may use the network 314 for communication or may communicate over other networks. In some embodiments, the server 316 may be a part of a geographic information system (GIS).

As noted above, the portable computer 306 may determine its present location via the satellite-based navigation system 308 or via signals received from the network 314 (e.g., via Wi-Fi or cell tower access point triangulation). In some embodiments, the location data may not be collected or used unless a user has expressly provided permission to collect and use the data after receiving notice of the collection of such data and how it is used. In some embodiments and for some uses, collected data is anonymized prior to use (e.g., to determine local traffic conditions). In other embodiments or uses, collected data is only stored long enough to serve the purposes of the user (e.g., long enough to relocate a user's parked vehicle).

As described above, in some embodiments the portable computer 306 is used to calculate the probability of a parking event of the vehicle 302 using possible parking indicators. As shown in FIG. 3, the portable computer 306 includes a parking event program 318 (e.g., a native application, a non-native application, etc.) and obtained possible parking indicators 320. As described above, the possible parking indicators 320 may include: a manual parking confirmation (e.g., an input from a user to store a location as the location of a parked vehicle); a disconnection from a vehicle dock; a disconnection from a vehicle's short-range radio network; a determination based on data obtained from an accelerometer of the portable computer indicating whether the user is walking or in a moving vehicle; the location of the portable computer at a known parking location; an arrival at a user-specific destination (such as a destination entered into a computer-based navigation application) and the location of the portable computer in a high traffic area or at a high traffic location (e.g., based on a traffic measurement obtained from a remote entity that provides traffic information).

The parking event program 318 may obtain the possible parking indicators 320 and calculate the probability of a parking event of the vehicle 302 based on the indicators 320. In some embodiments, the parking event program 318 may include a user interface that enables a user to input data and view the status of a parking event. In some embodiments, the parking event program 318 includes a user interface control, such as a button, switch, toggle, or other control that enables a user to indicate that the vehicle 302 is parked. The user interface control may be a physical control or a virtual control. For example, the control can be implemented as a touch sensitive element on a display of the portable computer, or an acoustically sensitive element on the portable computer. As described, this indication can be used as one of the possible parking indicators 320 and is processed in the manner described herein.

In some embodiments the parking event program 318 running on portable computer 306 may collect and process the possible parking indicators. In other embodiments, some or all of possible parking indicators may be obtained and processed by different programs executing on the portable computer 306, the server 316, or both. In some embodiments, the disconnection of the portable computer 306 from the vehicle dock 312 is obtained by the parking event program 318 directly or indirectly. For example, the parking event program 318 may detect the disconnect, or another program running on the portable computer 306 may detect the disconnection of the dock 312 and make the disconnection event available to other programs such as the parking event program 318 via an application programming interface (API). In some embodiments, the disconnection of the portable computer 306 from the short-range radio 310 of the vehicle 302 is obtained by the parking event program 318 directly or indirectly. Here again, for example, the parking event program 318 may detect the disconnection, or another program running on the portable computer 306 may detect the disconnection of the portable computer from the short-range radio 310 and make the disconnection event available to other programs such as the parking event program 318 via an application programming interface (API).

In some embodiments, a determination as to whether the user is on foot or in a moving vehicle is obtained from acceleration data made available to the parking event program 318. For example, in some embodiments, the portable computer 306 may include a program for measuring and processing acceleration data obtained from an accelerometer of the portable computer 306. Based on the accelerometer data, the program may determine that a portable computer 306 is being transported by foot (i.e., relatively slower and more periodic acceleration) or by a vehicle (i.e., relatively faster and less periodic acceleration). This determination may be made available to other programs such as the parking event program 318 via an API. In other embodiments, the parking event program 318 may access and process the accelerometer data to determine the user's status directly.

As described above, the location of the portable computer 306 is determined, such as from the satellite-based positioning system 308 or using other techniques. This location is used to determine possible parking indicators, such as whether the portable computer 306 is at a known parking location or whether the portable computer 306 is at a high traffic location. As described above in FIG. 2, for example, the parking event program 318 may obtain the location of the portable computer 306 and obtain a list of known parking locations in a geographic area that includes the portable computer location. For example, as shown in FIG. 3, in some embodiments the server 316 includes or has access to map data 322. The map data 322 may include parking data (e.g., known parking locations). In such embodiments, the portable computer 306 may request (via the parking event program 318 or other program) a list of known parking locations in an area that includes the location of the portable computer 306 from the server 316. The list of known parking locations is transmitted over the network 314 to the portable computer 306. As described above, the location of the portable computer 306 may be compared to the list of known parking locations to determine a possible parking indicator (i.e., whether the vehicle 302 is located in a parking garage, parking lot, parking space, or other parking location). In other embodiments, the location of the portable computer 306 is transmitted over the network 314 to the server 316, and the server 316 performs a comparison of the location to a list of known parking locations to determine the possible parking indicator.

In some embodiments, the parking event program 318 may obtain the location of the portable computer 306 and obtain a traffic measurement at that location or in an area that includes that location. For example, the map data 322 included on or accessible to the server 316 may also include traffic data (e.g., measurements of real-time traffic congestion on roads) in a geographic area. As described above in FIG. 2, the portable computer 306 (via the parking event program 318 or other program) may request a traffic measurement at or including a location from the server 316. The traffic measurement at the location or in an area that includes the location can be transmitted over the network 314 to the portable computer 306. As described above, the traffic measurement may be compared to a threshold to determine whether the vehicle 302 is located in a high traffic area (i.e., is not likely to be parked) or whether the vehicle is located in a low traffic area (i.e., is likely to be parked). It should be appreciated that in some embodiments the traffic measurement may be obtained from a different server than server 316 and using data different than map data 322. In other embodiments, the location of the portable computer 306 can be transmitted over the network 314 to the server 316, and the server 316 can determine whether the location is in a high traffic area or not, and return a suitable parking indicator to the portable computer 306.

As described above, in some embodiments the user's arrival at a user-specific destination is obtained as a possible parking indicator. The portable computer 306 may also include a maps program (e.g., a native maps application) capable of providing directions (e.g., audio and visual navigation) to a destination. The maps application can receive a destination from the user and direct the user from a present location to the destination. Upon arrival at the destination, the arrival event may be made available to other programs such as the parking event program 318 via an application programming interface (API). The parking event program may obtain the arrival as a possible parking indicator.

As described above in FIG. 1, the parking event program 318 assigns certainty measures to each obtained possible parking indicator and determines a probability of a parking event. The probability of the parking event is compared to a threshold to determine if a parking event occurred (i.e., if the vehicle 302 is parked). If a parking event occurred, the parking event is stored on the portable computer 306. In some embodiments, the parking event may be transmitted to the server 316 (or other server) via the network 314 and used for additional purposes (e.g., to offer an advertisement to the user or a coupon for discount parking at a known parking location).

In some embodiments a parking event program may additionally or alternatively be executed on the server 316. In such embodiments, some or all of the processing described above may be performed by the server 316. For example, in some embodiments the server 316 may obtain the possible parking indicators and calculate the probability of a parking event. In other embodiments the portable computer 306 may obtain the possible parking indicators and the server 316 may calculate the probability of a parking event. In yet other embodiments, some of the possible parking indicators may be obtained by the server 316 and some of the possible parking indicators may be obtained by the portable computer 306. Additionally, other embodiments may yet include other arrangements of steps between the server 316 and the portable computer 306.

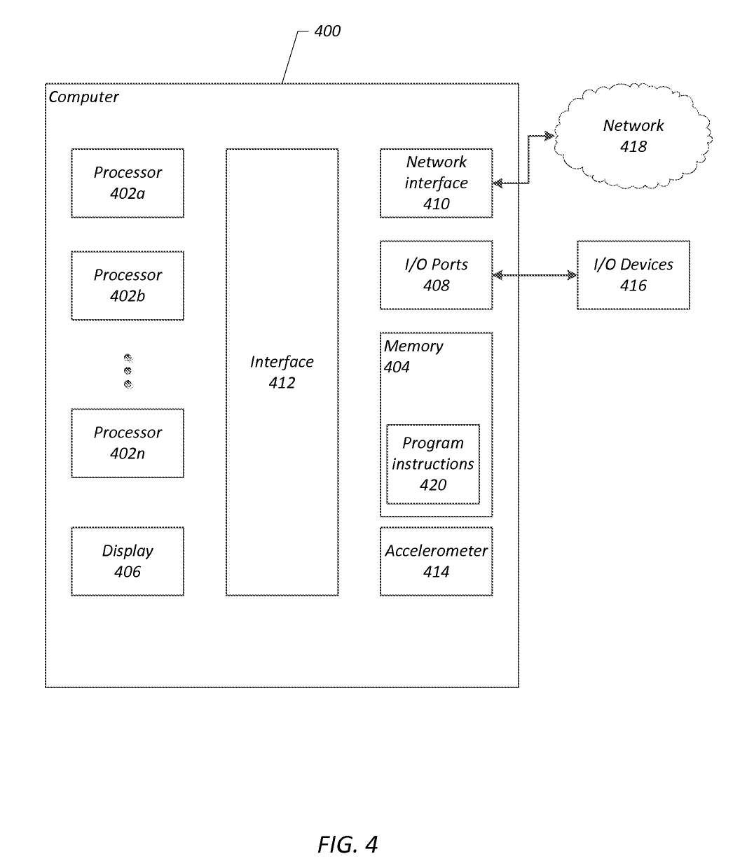

FIG. 4 depicts a computer 400 in accordance with an embodiment of the present invention. Various portions or sections of systems and methods described herein include or are executed on one or more computers similar to computer 400 and programmed as special-purpose machines executing some or all steps of processes described above as executable computer code. Further, processes, modules, and other components described herein may be executed by one or more processing systems similar to that of computer 400.

The computer 400 may include various components that contribute to the function of the device and enable the computer 400 to function in accordance with the techniques discussed herein. As will be appreciated, some components of computer 400 may be provided as internal or integral components of the computer 400 and some components may be provided as external or connectable components. Moreover, FIG. 4 depicts one example of a particular implementation and is intended to illustrate the types of components and functions that may be present in various embodiments of the computer 400.

Computer 400 may include a combination of devices or software that may perform or otherwise provide for the performance of the techniques described herein. For example, computer 400 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. Computer 400 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 4, the computer 400 may include one or more processors (e.g., processors 402a-402n), a memory 404, a display 406, I/O ports 408 a network interface 410, an interface 412, and an accelerometer 414. Additionally, the computer 400 may include or be coupled to additional I/O devices 416.

In addition, the computer 400 may allow a user to connect to and communicate (e.g., send and receive data) through a network 418 (e.g., the Internet, a local area network, a wide area network, etc.) and, in some embodiments, to acquire data from a satellite-based positioning system (e.g., GPS). For example, the computer 400 may allow a user to communicate using e-mail, text messaging, instant messaging, or using other forms of electronic communication, and may allow a user to obtain the location of the device from a satellite-based positioning system.

In some embodiments, the display 406 may include a liquid crystal display (LCD) an organic light emitting diode (OLED) display, or other display types. The display 406 may display a user interface (e.g., a graphical user interface) executed by the processor 402 of the computer 400. The display 406 may also display various indicators to provide feedback to a user, such as power status, call status, memory status, network status etc. These indicators may be incorporated in the user interface displayed on the display 406. In some embodiments, the display 406 may include or be provided in conjunction with touch sensitive elements through which a user may interact with the user interface. In such embodiments, a touch-sensitive display may be referred to as a “touch screen” and may also be known as or called a touch-sensitive display system.

The processor 402 may provide the processing capability to execute the operating system, programs, user interface, and other functions of the computer 400. The processor 402 may include one or more processors and may include “general-purpose” microprocessors, special purpose microprocessors, such as application-specific integrated circuits (ASICs), or any combination thereof. In some embodiments, the processor 402 may include one or more reduced instruction set (RISC) processors, such as those implementing the Advanced RISC Machine (ARM) instruction set. Additionally, the processor 402 may include single-core processors and multicore processors and may include graphics processors, video processors, and related chip sets. Accordingly, the computer 400 may be a uni-processor system having one processor (e.g., processor 402a), or a multi-processor system having two or more suitable processors (e.g., 402a-402n). Multiple processors may be employed to provide for parallel or sequential execution of the techniques described herein. Processes, such as logic flows, described herein may be performed by the processor 402 executing one or more computer programs to perform functions by operating on input data and generating corresponding output. The processor 402 may receive instructions and data from a memory (e.g., system memory 404).

The memory 404 (which may include one or more tangible non-transitory computer readable storage mediums) may include volatile memory and non-volatile memory accessible by the processor 402 and other components of the computer 400. The memory 404 may store a variety of information and may be used for a variety of purposes. For example, the memory 404 may store executable computer code, such as the firmware for the computer 400, an operating system for the computer 400, and any other programs or other executable code for providing functions of the computer 400. Such executable computer code may include program instructions 420 executable by a processor (e.g., one or more of processors 402a-402n) to implement one or more embodiments of the present invention, such as the process 100 and the process 200 described above. Program instructions 420 may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more processors located locally at one site or distributed across multiple remote sites and interconnected by a communication network. Additionally, the memory 404 may be used for buffering or caching during operation of the computer 400.

As mentioned above, the memory 404 may include volatile memory, such as random access memory (RAM). The memory 404 may also include non-volatile memory, such as ROM, flash memory, a hard drive, other suitable optical, magnetic, or solid-state storage mediums or any combination thereof. The memory 404 may store data files such as media (e.g., music and video files), software (e.g., for implementing functions on computer 400), user preference information, payment transaction information, wireless connection information, contact information (e.g., an address book), and any other suitable data.

The interface 412 may include multiple interfaces and may enable communication between various components of the computer 400, the processor 402, and the memory 404. In some embodiments, the interface 412, the processor 402, memory 404, and one or more other components of the computer 400 may be implemented on a single chip, such as a system-on-a-chip (SOC). In other embodiments, these components, their functionalities, or both may be implemented on separate chips. The interface 412 may coordinate I/O traffic between processors 402a-402n, the memory 404, the network interface 410 or any other devices or a combination thereof. The interface 412 may perform protocol, timing or other data transformations to convert data signals from one component (e.g., the memory 404) into a format suitable for use by another component (e.g., processors 402a-402n). The interface 412 may implement various types of interfaces, such as Peripheral Component Interconnect (PCI) interfaces, the Universal Serial Bus (USB) interfaces, Thunderbolt interfaces, Firewire (IEEE-1394) interfaces, and so on.

The computer 400 may also include an accelerometer 414. The accelerometer 414 includes one or more sensors to measure proper acceleration of the computer 400. The accelerometer 414. Such an accelerometer 414 may be used to determine the orientation (e.g., portrait of landscape) of the computer 400, to detect motion of the computer 400, etc. In some embodiments, the accelerometer 414 includes one or more piezoelectric sensors. The computer 400 may also include an input and output port 408 to enable connection of additional devices, such as I/O devices 416. Embodiments of the present invention may include any number of input and output ports 408, including headphone and headset jacks, universal serial bus (USB) ports, Firewire (IEEE-1394) ports, Thunderbolt ports, and AC and DC power connectors. Further, the computer 400 may use the input and output ports to connect to and send or receive data with any other device, such as other portable computers, personal computers, printers, etc. In some embodiments, the input and output ports 408 may enable connection to a dock, such as dock of a vehicle. When docked, the computer 400 may receive power from the dock and send and receive data to another computer or system via the dock. The I/O devices may also include a receiver configured to receive signals from a satellite-based positioning system (e.g., GPS).

The computer 400 depicted in FIG. 4 also includes a network interface 410. The network interface 410 may include a wired network interface card (NIC), a wireless (e.g., radio frequency) network interface card, or combination thereof. The network interface 410 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 410 may communicate with networks (e.g., network 418), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for determining parking of a vehicle, the method comprising:
obtaining, by one or more processors, one or more parking indicators associated with a user and a vehicle, the one or more parking indicators selected from the group consisting of:
a manual parking confirmation from a user of a portable computer;
a disconnection of the portable computer from a dock of the vehicle;
a disconnection of the portable computer from a short-range radio provided by the vehicle;
a determination based on data received from an accelerometer of the portable computer;
a determination that a location of the portable computer is a known parking location;
an arrival at a user-specific destination; and
a determination that the location of the portable computer is not in a high traffic area;
calculating, by one or more processors, a probability of a parking event of the vehicle based on the one or more parking indicators;
determining, by one or more processors, that the probability of the parking event is greater than a threshold value; and
storing, by one or more processors, the location of the parking event on the portable computer.

2. The computer-implemented method of claim 1, wherein obtaining a determination that a location of the portable computer is a known parking location further comprises:
determining a location of the portable computer;
obtaining a list of known parking locations in a geographic area that includes the location of the portable computer; and
identifying the location of the portable computer as a location within the list of known parking locations.

3. The computer-implemented method of claim 1, wherein obtaining a determination that the location of the portable computer is not in a high traffic area further comprises:
determining a location of the portable computer;
obtaining a measurement of traffic congestion in an area that includes the location of the portable computer from a remote server via a network accessible by the portable computer.

4. The computer-implemented method of claim 1, wherein calculating the probability of the parking event comprises assigning a certainty measure to each of the one or more possible parking indicators obtained, and combining the certainty measures.

5. The computer-implemented method of claim 1, wherein obtaining a determination based on data received from an accelerometer of the portable computer further comprises:
matching the acceleration data to one of a plurality of acceleration profiles; and
determining, based on the matched profile, whether the user is traveling in the vehicle or on foot.

6. A non-transitory tangible computer-readable storage medium having executable computer code stored thereon for determining parking of a vehicle, the code comprising a set of instructions that causes one or more processors to perform the following:
obtaining, by one or more processors, one or more parking indicators associated with a user and a vehicle, the one or more parking indicators selected from the group consisting of:
a manual parking confirmation from a user of a portable computer;
a disconnection of the portable computer from a dock of the vehicle;
a disconnection of the portable computer from a short-range radio provided by the vehicle;
a determination based on data received from an accelerometer of the portable computer;
a determination that a location of the portable computer is a known parking location;
an arrival at a user-specific destination; and
a determination that the location of the portable computer is not in a high traffic area;
calculating, by one or more processors, a probability of a parking event of the vehicle based on the one or more parking indicators;
determining, by one or more processors, that the probability of the parking event is greater than a threshold value; and
storing, by one or more processors, the location of the parking event on the portable computer.

7. The non-transitory tangible computer-readable storage medium of claim 6, wherein the computer code further comprises a set of instructions that causes one or more processors to perform the following: wherein obtaining a determination that a location of the portable computer is a known parking location further comprises:
determining a location of the portable computer;
obtaining a list of known parking locations in a geographic area that includes the location of the portable computer; and
identifying the location of the portable computer as a location within the list of known parking locations.

8. The non-transitory tangible computer-readable storage medium of claim 6, wherein obtaining a determination that the location of the portable computer is not in a high traffic area further comprises:
determining a location of the portable computer;
obtaining a measurement of traffic congestion in an area that includes the location of the portable computer from a remote server via a network accessible by the portable computer.

9. The non-transitory tangible computer-readable storage medium of claim 6, wherein calculating the probability of the parking event comprises assigning a certainty measure to each of the obtained one or more possible parking indicators and combining the certainty measures.

10. The non-transitory tangible computer-readable storage medium of claim 6, wherein the obtaining a determination based on data received from an accelerometer of the portable computer further
matching the acceleration data to one of a plurality of acceleration profiles; and
determining based on the matched profile whether the user is traveling in the vehicle or on foot.

11. A system for determining parking of a vehicle, the system comprising:
one or more processors;
a tangible non-transitory memory accessible by the one or more processors, the memory having computer code stored thereon, the code comprising a set of instructions that causes one or more processors to perform the following:
obtaining, by one or more processors, one or more parking indicators associated with a user and a vehicle, the one or more parking indicators selected from the group consisting of:
a manual parking confirmation from a user of a portable computer;
a disconnection of the portable computer from a dock of the vehicle;
a disconnection of the portable computer from a short-range radio provided by the vehicle;
a determination based on data received from an accelerometer of the portable computer;
a determination that a location of the portable computer is a known parking location;
an arrival at a user-specific destination; and
a determination that the location of the portable computer is not in a high traffic area;
calculating, by one or more processors, a probability of a parking event of the vehicle based on the one or more parking indicators;
determining, by one or more processors, that the probability of the parking event is greater than a threshold value; and
storing, by one or more processors, the location of the parking event on the portable computer

12. The system of claim 11, wherein obtaining a determination that a location of the portable computer is a known parking location further comprises:
determining a location of the portable computer;
obtaining a list of known parking locations in a geographic area that includes the location of the portable computer; and
identifying the location of the portable computer as a location within the list of known parking locations.

13. The system of claim 11, wherein obtaining a determination that the location of the portable computer is not in a high traffic area further comprises:
determining a location of the portable computer;
obtaining a measurement of traffic congestion in an area that includes the location of the portable computer from a remote server via a network accessible by the portable computer

14. The system of claim 11, wherein calculating the probability of the parking event comprises assigning a certainty measure to each of the one or more possible parking indicators obtained and combining the certainty measures.

15. The system of claim 11, wherein obtaining a determination based on data received from an accelerometer of the portable computer further comprises:
matching the acceleration data to one of a plurality of acceleration profiles; and
determining, based on the matched profile, whether the user is traveling in the vehicle or on foot.
